(19) United States
(12) Patent Application Publication
(10) Pub. No.: US 2019/0249707 A1
(43) Pub. Date: Aug. 15, 2019

(54) INSERT MEMBER FOR OPEN END WHEEL NUT

(71) Applicant: KYO-EI INDUSTRIAL CORPORATION, Osaka-shi (JP)

(72) Inventor: Daisaku KISHIDA, Osaka-shi (JP)

(73) Assignee: KYO-EI INDUSTRIAL CORPORATION, Osaka-shi (JP)

(21) Appl. No.: 16/000,800

(22) Filed: Jun. 5, 2018

(30) Foreign Application Priority Data
Feb. 13, 2018 (JP) 2018-022695

(51) Int. Cl. F16B 37/12; F16B 39/284; F16B 37/14

(52) U.S. Cl. CPC F16B 37/125; B60B 3/16; F16B 37/14; F16B 39/284

(57) ABSTRACT

Provided is an insert member for an open end wheel nut, which is capable of improving the workability of dressing up the car in the case of mounting a wheel using the open end wheel nuts. An insert member 1 for an open end wheel nut includes a shaft body 2 provided on an outer periphery thereof with a male thread 2a to be screwed on a female thread portion 10a of an open end wheel nut 10 from one end thereof. The shaft body 2 includes: a hexagonal hole 5 provided at an opening on the one end of the open end wheel nut 10; and a recess 2b provided at an opening on the other end of the open end wheel nut 10. A spring 3 that urges the shaft body 2 in an axial direction thereof is provided in the recess 2b.

### CROSS-REFERENCE TO RELATED APPLICATIONS

The present application claims priority under 35 U.S.C. § 119 to Japanese Patent Application No. 2018-022695, filed Feb. 13, 2018, entitled “Insert Member for Open End Wheel Nut.” The contents of this application are incorporated herein by reference in their entirety.

### BACKGROUND OF THE INVENTION

### 1. Field of the Invention

The present invention relates to an insert member for an open end wheel nut to be used in mounting a wheel.

### 2. Description of the Related Art

In a known wheel mounting structure, hub bolts are fixed to a vehicle, and wheel nuts are tightened on the hub bolts, whereby a wheel is mounted to the vehicle (Japanese Patent Application Laid Open JP 10-324102 A).

In some cases, wheels and wheel nuts provided for a new car are replaced for the purpose of dressing up the car. The wheel nut comes in two types: a cap nut (closed end nut); and a through nut (open end nut).

### SUMMARY OF THE INVENTION

In replacing the wheels and wheel nuts for more attractive appearance, it is desired that the replacement take less time and effort while obtaining the dress up effect.

An object of the present invention is to provide an insert member for an open end wheel nut, which is capable of improving the workability of dressing up the car in the case of mounting a wheel using the open end wheel nuts.

### Solution to Problem

The insert member for the open end wheel nut in accordance with the present invention is an insert member for an open end wheel nut to be used in mounting a wheel by tightening the open end wheel nut on one of hub bolts that are fixed to a vehicle. The insert member comprises a shaft body provided on an outer periphery thereof with a male thread to be screwed on a female thread portion of the open end wheel nut from one end thereof. The shaft body includes: a tool engagement portion provided at an opening on the one end of the open end wheel nut; and a recess provided at an opening on the other end of the open end wheel nut. A spring that urges the shaft body in an axial direction thereof is provided in the recess.

Regarding the hub bolt, one that is provided on a vehicle may be used as it is. Alternatively, in the case of a vehicle in which a female thread is provided on a hub, a bolt may be screwed onto the female thread from outside, and the bolt thus screwed may be used as “a hub bolt that is fixed to a vehicle” described above.

With the insert member for the open end wheel nut in accordance with the present invention, the insert member is screwed on the open end wheel nut from one end (base end) side, which is accomplished by bringing a tool into engagement with the tool engagement portion to rotate it in a state where the open end wheel nut has been screwed on the hub bolt. The length of the insert member is designed such that a base end of the insert member is located close to a base end opening of the open end wheel nut, whereby, apparently, the hub bolt may be lengthen by a length corresponding to that of the insert member. Mounting the insert member may be performed at the last stage of an ordinary operation when the wheel is replaced. Therefore, a dress up effect is obtained, i.e., the lengthening of the hub bolt is achieved, without taking time and effort.

The insert member is pressed against the hub bolt with the elastic force of the spring, whereby an axial force acts on the open end wheel nut and the insert member to prevent the open end wheel nut from becoming loose.

In some cases, a ball that is urged by the spring toward an opening of the recess of the shaft body is provided in the recess, and caulking an edge portion of the opening of the recess of the shaft body prevents the spring and the ball from dropping off. Alternatively, in some cases, a pin that is urged by the spring toward an opening of the recess of the shaft body is provided in the recess, and screwing a bolt on a female thread provided on a peripheral surface of the recess of the shaft body prevents the spring and the pin from dropping off.

With these configurations, the spring is prevented from dropping off from the shaft body, which facilitates the handling of the insert member.

With the insert member for the open end wheel nut in accordance with the present invention, the apparent length of the hub bolt may be increased without exchanging the hub bolt.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cutting-into-half cross sectional view of an insert member for an open end wheel nut in accordance with a first embodiment of the present invention;

FIG. 2 is a view of the insert member for the open end wheel nut in accordance with the first embodiment, which is viewed from the distal end side;

FIG. 3 is a cutting-into-half cross sectional view of a wheel mounting structure in accordance with one embodiment, using the insert member for the open end wheel nut in accordance with the first embodiment;

FIG. 4 is a cutting-into-half cross sectional view of an insert member for an open end wheel nut in accordance with a second embodiment of the present invention;

FIG. 5A is a cutting-into-half cross sectional view of a bolt to be used in the insert member for the open end wheel nut in accordance with the second embodiment; and

FIG. 5B shows the bolt to be used in the insert member for the open end wheel nut in accordance with the second embodiment, which is viewed from the distal end side.

### DESCRIPTION OF THE EMBODIMENTS

Embodiments of the present invention will be described below with reference to the accompanying drawings.

In the following description, a side closer to a hub (vehicle) on which a wheel is mounted is referred to as a distal end; and a side opposite to the distal end, that is, a side closer to an operator who performs a wheel mounting operation is referred to as a base end.

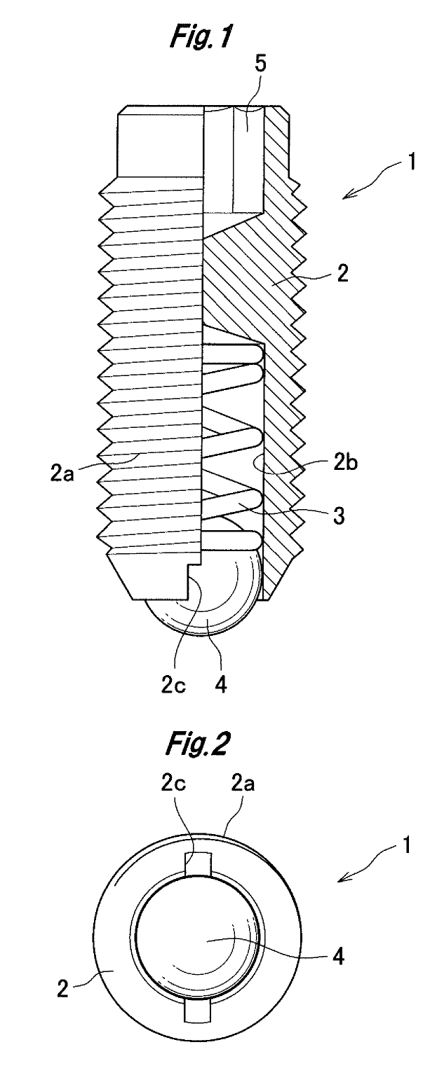

FIG. 1 and FIG. 2 each show an insert member for an open end wheel nut in accordance with a first embodiment of the present invention. An insert member 1 for an open end wheel nut includes: a shaft body 2 provided on an outer periphery thereof with a male thread 2a; and a compression coil spring (spring) 3 and a ball 4 that are fit into a recess 2b provided on the distal end side of the shaft body 2.

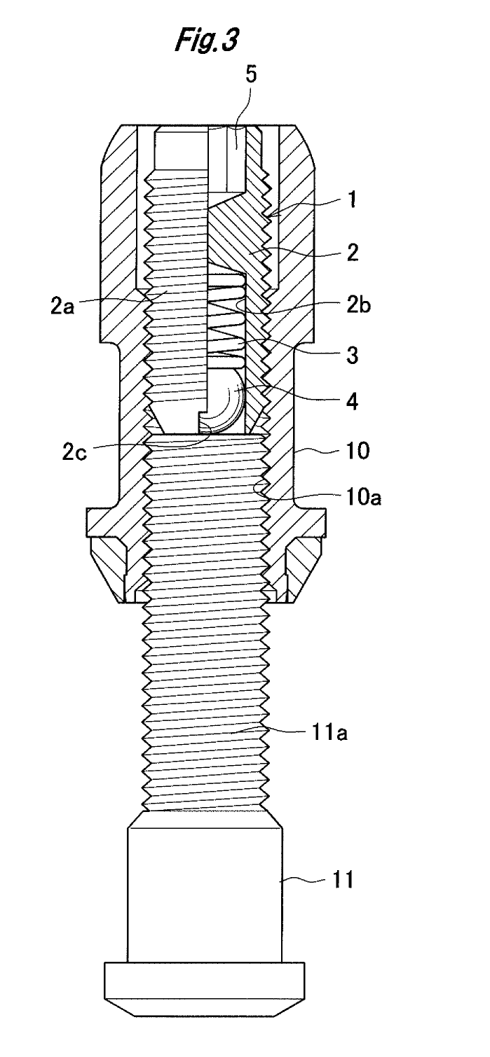

When a wheel (not shown) on which a tire has been mounted is to be attached to a vehicle, and in the case where an open end wheel nut 10 is tightened on a hub bolt 11 that has been fixed to the vehicle, as shown in FIG. 3, this insert member 1 for the open end wheel nut is used. The shaft body 2 has a male thread based on the same standard as for the hub bolt 11. This means that, using this insert member 1 for the open end wheel nut allows the apparent length of the hub bolt to be increased to combined lengths of: the hub bolt 11 fixed to the vehicle body; and the insert member 1 for the open end wheel nut.

The open end wheel nut 10 includes a female thread portion 10a to be screwed on a male thread portion 11a of the hub bolt 11. In the case where a cap nut (closed end nut) is used, there is a concern about the possibility that the wheel mounting operation cannot be accomplished when using a longer hub bolt 11 and yet failing to replace the closed end nut with another one having a longer female thread. However, in the case where the open end wheel nut 10 is used, there is no such a concern. By using the open end wheel nut 10, a base end portion of the shaft body 2 of the insert member 1 for the open end wheel nut is located close to a base end opening of the open end wheel nut 10.

The shaft body 2 is provided at a base end portion thereof with a hexagonal hole 5 that is open to the base end. The hexagonal hole 5 is used as a tool engagement portion to be engaged with a hexagonal wrench for rotating the shaft body 2. The hexagonal hole 5 serving as a tool engagement portion may be a bottomed hole having an appropriate non-circular cross sectional shape instead of a hexagonal cross sectional shape. A tool that can be engaged with the bottomed hole is used as a tool for turning the insert member 1 for the open end wheel nut.

After screwing the open end wheel nut 10 on the hub bolt 11, the insert member 1 for the open end wheel nut is attached by fitting the insert member 1 into the open end wheel nut 10 from the base end side and turning the shaft body 2 with the hexagonal wrench.

The ball 4 is provided at a distal end portion of the recess 2b, with the ball 4 being urged in the direction toward the distal end by the compression coil spring 3 provided at the base end side of the recess 2b. The shaft body 2 is provided at a distal end portion thereof with cutouts 2c, which are caulked, whereby the ball 4 is movable between: an initial position in which an amount of projection of the ball 4 from the shaft body 2 is set at an appropriate value; and an maximum displacement position in which the ball 4 enters the recess 2b while being urged due to the elastic force of the compression coil spring 3.

The specifications of the compression coil spring 3 is determined such that the elastic force of the compression coil spring 3 takes on an appropriate value when the shaft body 2 comes into contact with the hub bolt 11.

In the state where the insert member 1 for the open end wheel nut is not loaded in the axial direction, part of the ball 4 is exposed so as to protrude from a distal end opening of the shaft body 2, as shown in FIG. 1. When the force in the direction toward the base end acts on the ball 4, the ball 4 moves in the direction toward the base end in proportion to the force acting on the ball 4.

In the state shown in FIG. 3, rotating the shaft body 2 moves the ball 4 from the initial position toward the base end, whereby the hub bolt 11 and the insert member 1 for the open end wheel nut exert axial forces on each other to be integrated. When the ball 4 is in the maximum displacement position in which the ball 4 enters the recess 2b, it becomes difficult to further rotate the shaft body 2, whereby the operation of attaching the insert member 1 for the open end wheel nut is accomplished. The length of the insert member 1 for the open end wheel nut is designed such that the base end of the insert member 1 is located close to the base end opening of the open end wheel nut 10 (i.e., such that the base end of the insert member 1 for the open end wheel nut is approximately flush with the base end of the open end wheel nut 10).

In the state shown in FIG. 3, when viewing the vehicle from outside, the external appearance is the same as the case where the hub bolt 11 is replaced by a longer one, whereby a dress up effect that provides the same external appearance as the case where the hub bolt 11 is replaced by a longer one can be obtained without replacing the hub bolt 11.

To replace the hub bolt 11 with a longer one, the brake has to be once removed, which is troublesome. However, in the present invention, the attachment of the insert member 1 for the open end wheel nut is performed after the wheel replacing operation that is accomplished by tightening the open end wheel nut 10. Therefore, the additional work required for the attachment of the insert member 1 is just tightening the insert member 1 for the open end wheel nut with a hexagonal wrench, whereby the dress up effect that enables the lengthening of the hub bolt can be obtained without taking much time and effort.

In addition, in this state, the insert member 1 for the open end wheel nut is pressed against the hub bolt 11 with the elastic force of the compression coil spring 3 and the axial force acts on the open end wheel nut 10 and the insert member 1, whereby an effect of locking the open end wheel nut 10 is also obtained.

To obtain the locking effect, the ball 4 is not a requisite component and caulking the distal end portion of the shaft body 2 is not required. However, if the ball 4 is used and the dropping off of the ball 4 is prevented by the caulking, the handling of the insert member 1 for the open end wheel nut becomes easy.

For a vehicle in which a female thread is provided in a hub of the vehicle body, a bolt having an appropriate length is screwed into the female thread of the hub of the vehicle body, and the bolt thus screwed is used as a hub bolt 11, whereby the insert member 1 for the open end wheel nut may be used.

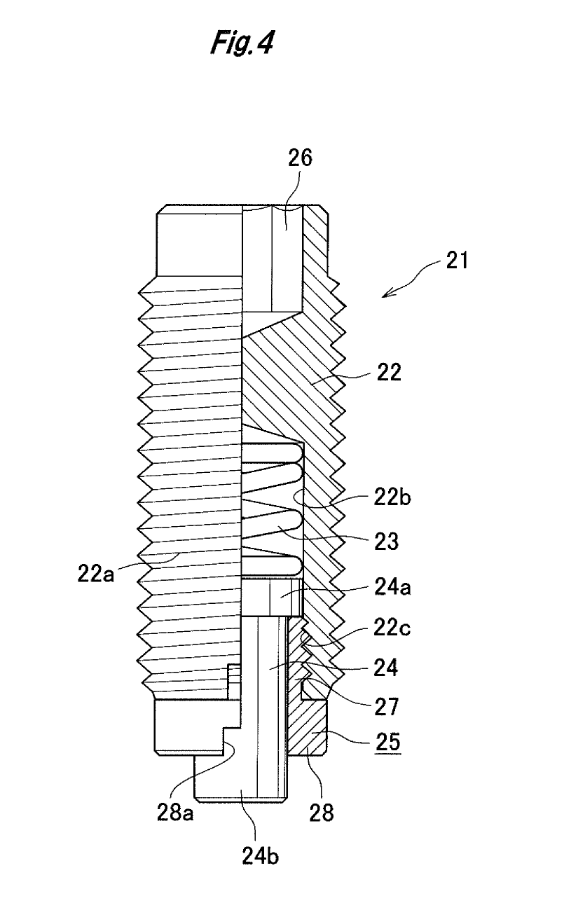

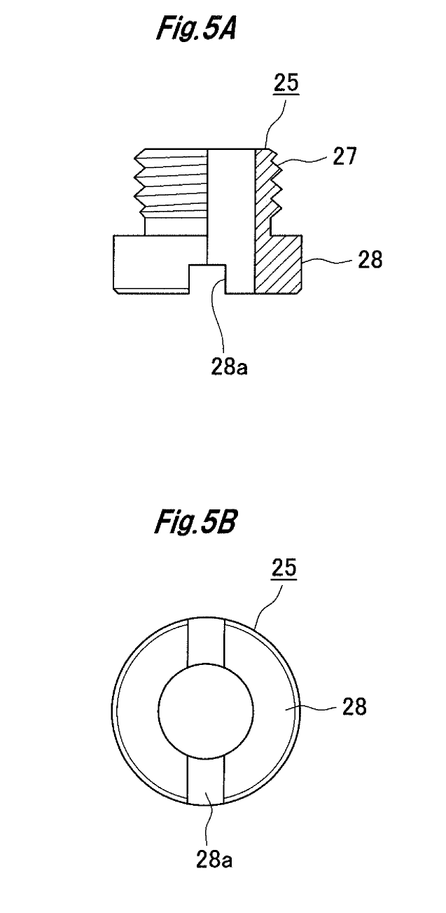

FIG. 4 and FIG. 5 each show an insert member for an open end wheel nut in accordance with a second embodiment of the present invention. An insert member for an open end wheel nut includes: a shaft body 22 provided on an outer periphery thereof with a male thread 22a; and a compression coil spring (spring) 23, a pin 24, and a bolt 25 that are fit into a recess 22b provided on the distal end side of the shaft body 22.

The shaft body 22 is provided at a base end portion thereof with a hexagonal hole 26 that is open to the base end, as in the first embodiment.

The second embodiment differs from the first embodiment in that the ball 4 is replaced by the pin 24 and in that the bolt 25 prevents the compression coil spring 23 and the pin 24 from dropping off, instead of caulking prevents the compression coil spring 3 and the ball 4 from dropping off. Due to the above-described configuration, a female thread 22c to be screwed on the bolt 25 is provided on a peripheral surface of a distal end side portion of the recess 22b of the shaft body 22.

The pin 24 is composed of a head portion 24a and a shaft portion 24b and is provided at a distal end portion of the recess 22b, with the pin 24 being urged in the direction toward the distal end by the compression coil spring 23 provided on a base end side of the recess 22b of the shaft body 22.

As also shown in FIG. 5, the bolt 25 has a stepped cylindrical shape and includes: at a base end side thereof, a male thread portion 27 to be screwed into the female thread 22c of the shaft body 22; and, at a distal end side thereof, a head portion 28 having an outer diameter greater than that of the male thread portion 27. The head portion 28 is provided on a distal end surface thereof with slots 28a for engagement with a tool to rotate the bolt 25.

The inner diameter of the bolt 25 is slightly greater than the outer diameter of the shaft portion 24b of the pin 24. The male thread portion 27 of the bolt is screwed into the female thread 22c of the shaft body 22 from the distal end side, whereby a distal end of the head portion 24a of the pin 24 is received by a base end of the male thread portion 27 of the bolt 25. With this configuration, the compression coil spring 23 and the pin 24 are prevented from dropping off.

In the state shown in FIG. 4, the pin 24 cannot move in the direction toward the distal end and can move in the direction toward the base end against the elastic force of the spring. The pin 24 is movable between: an initial position in which an amount of projection of the pin 24 from the shaft body 22 is set at an appropriate value; and a maximum displacement position in which the pin 24 enters the recess 22b while being urged due to the elastic force of the compression coil spring 23.

In the state where the insert member 21 for the open end wheel nut is not loaded in the axial direction, part of the pin 24 is exposed so as to protrude from a distal end opening of the shaft body 22, as shown in FIG. 4. When the force in the direction toward the base end acts on the pin 24, the pin 24 moves in the direction toward the base end in proportion to the force acting on the pin 24.

Although not shown, rotating the shaft body 22 moves the pin 24 from the initial position in the direction toward the base end, whereby the hub bolt 11 and the insert member 21 for the open end wheel nut exert axial forces on each other to be integrated. When the pin 24 is in the maximum displacement position in which the pin 24 enters the recess 22b, it becomes difficult to further rotate the shaft body 22, and the mounting operation of the insert member 21 for the open end wheel nut is accomplished.

### REFERENCE SIGNS LIST

1: insert member for open end wheel nut
2: shaft body
2a: male thread
2b: recess
3: compression coil spring (spring)
4: ball
5: hexagonal hole (tool engagement portion)
10: open end wheel nut
10a: female thread portion
11: hub bolt
21: insert member for open end wheel nut
22: shaft body
22a: male thread
22b: recess
22c: female thread
23: compression coil spring (spring)
24: pin
25: bolt
26: hexagonal hole (tool engagement portion)

What is claimed is:

1. An insert member for an open end wheel nut to be used in mounting a wheel by tightening the open end wheel nut on one of hub bolts that are fixed to a vehicle, wherein
the insert member comprises a shaft body provided on an outer periphery thereof with a male thread to be screwed on a female thread portion of the open end wheel nut from one end thereof,
the shaft body includes: a tool engagement portion provided at an opening on the one end of the open end wheel nut; and a recess provided at an opening on the other end of the open end wheel nut, and
a spring that urges the shaft body in an axial direction thereof is provided in the recess.

2. The insert member for the open end wheel nut according to claim 1, wherein a ball that is urged by the spring toward the opening on the other end of the open end wheel nut is provided in the recess, and caulking an edge portion of the opening of the recess of the shaft body prevents the spring and the ball from dropping off.

3. The insert member for the open end wheel nut according to claim 1, wherein a pin that is urged by the spring toward an opening of the recess of the shaft body is provided in the recess, and screwing a bolt on a female thread provided on a peripheral surface of the recess of the shaft body prevents the spring and the pin from dropping off.
